(19) United States
(12) Patent Application Publication
(10) Pub. No.: US 2021/0283591 A1
(43) Pub. Date: Sep. 16, 2021

(54) METHOD FOR THE INDIRECT ADDITION OF AN ORGANIC COMPOUND TO A POROUS SOLID

(71) Applicant: IFP Energies nouvelles, Rueil-Malmaison (FR)

(72) Inventors: Florent GUILLOU, Ternay (FR); P-Louis CARRETTE, Lyon (FR); Bertrand GUICHARD, St. Genis Laval (FR)

(73) Assignee: IFP Energies nouvelles, Rueil-Malmaison (FR)

(21) Appl. No.: 16/610,217

(22) PCT Filed: Apr. 24, 2018
(86) PCT No.: PCT/EP2018/060407

§ 371 Date: Nov. 1, 2019

(30) Foreign Application Priority Data
May 4, 2017 (FR) 1753922

(51) Int. Cl. B01J 37/02; B01J 37/20; B01J 27/19; B01J 35/02

(52) U.S. Cl. CPC B01J 37/0205; B01J 37/0238; B01J 35/023; B01J 27/19; B01J 37/20

(57) ABSTRACT

The present invention relates to a process for adding an organic compound to a porous solid wherein, in an open or closed chamber, a first batch of porous solid rich in an organic compound is brought together with a second batch of porous solid low in said organic compound. The step of bringing the porous solids together is carried out under temperature, pressure and time conditions such that a fraction of said organic compound is transferred gaseously from the first batch of porous solid to the second batch of porous solid.

The present invention relates to a process for adding an organic compound to a porous solid, in particular to a porous catalyst support. The process according to the invention may be incorporated into a process for preparing a heterogeneous catalyst said to be “additivated” with an organic compound comprising a porous support on which at least one metal from group VIB and/or at least one metal from group VIII is deposited.

### PRIOR ART

Conventional hydrotreating catalysts generally comprise a support based on an oxide of a metal (for example aluminum) or of a metalloid (for example silicon) and an active phase based on at least one metal from group VIB and/or on at least one metal from group VIII in the oxide forms thereof and optionally phosphorus. The preparation of these catalysts generally comprises a step of impregnating the metals and the phosphorus on the support, optionally followed by a maturing step, followed by drying and calcining enabling the active phase to be obtained in the oxide forms thereof. Before the use thereof in a hydrotreating and/or hydrocracking reaction, these catalysts are generally subjected to a sulfidation in order to form the active species.

The addition of an organic compound to the hydrotreating catalysts in order to improve their activity has been recommended by those skilled in the art, notably for catalysts which have been prepared by impregnation optionally followed by a maturing step, and followed by drying. Many documents describe the use of various ranges of organic compounds, such as nitrogen-containing organic compounds and/or oxygen-containing organic compounds.

One family of compounds now well known from the literature relates to chelating nitrogen-containing compounds (EP 181035, EP 1043069 and U.S. Pat. No. 6,540,908) with, by way of example, ethylenediaminetetraacetic acid (EDTA), ethylenediamine, diethylenetriamine or nitrilotriacetic acid (NTA).

In the family of oxygen-containing organic compounds the use of monools, diols or polyols which are optionally etherified is described in documents WO96/41848, WO01/76741, U.S. Pat. Nos. 4,012,340, 3,954,673, EP 601722 and WO 2005/035691. The prior art mentions less frequently compounds comprising ester functions (EP 1046424, WO2006/077326).

Several patents are also found that claim the use of carboxylic acids (EP 1402948, EP 482817). In particular, in document EP 482817, citric acid, and also tartaric, butyric, hydroxyhexanoic, malic, gluconic, glyceric, glycolic and hydroxybutyric acids have been described.

The processes for preparing additivated catalysts generally use an impregnation step in which the organic compound is introduced, optionally in solution in a solvent, so as to fill the entire porosity of the support, optionally impregnated with metal precursors, in order to obtain a homogeneous distribution. This results in using large amounts of compound or in diluting the organic compound in a solvent. After impregnation, a drying step is then necessary to eliminate the excess compound or the solvent and thus free the porosity needed for the use of the catalyst. Added to the additional cost linked to the excess organic compound or to the use of a solvent is the cost of an additional preparatory individual drying step, this step being energy consuming. During the drying step, the evaporation of the solvent may also be accompanied by a partial loss of the organic compound by vaporization and therefore by a loss of catalytic activity.

One objective of the invention is to propose a process for adding an organic compound to a porous solid, in particular to a catalyst support or to a catalyst precursor and a process for preparing a catalyst which is simplified and less expensive to implement industrially.

### SUMMARY OF THE INVENTION

A first subject of the invention relates to a process for adding an organic compound to a porous solid comprising a step a) wherein, in a closed or open chamber, a first batch of porous solid rich in an organic compound is brought together with a second batch of porous solid low in said organic compound, step a) being carried out under temperature, pressure and time conditions such that a fraction of said organic compound is transferred gaseously from the first batch of porous solid to the second batch of porous solid.

Within the context of the invention, the term “bringing together” denotes the fact that the solids are present at the same time in the chamber without there necessarily being a physical contact of the two batches of solids.

According to the invention, the term “rich in organic compound” expresses the fact that the solid contains more than 50% of the total amount of said organic compound used in step a), preferably at least 60%, preferably at least 80%, preferably at least 90% and preferably 100%.

According to one embodiment, the porous solid rich in organic compound contains 100% of the total amount involved in step a) and the second batch of solid low in organic compound therefore contains 0% of the total amount of said organic compound.

Advantageously, the bringing-together step a) is carried out at a temperature below the boiling point of the organic compound.

According to one embodiment, step a) of bringing said batches together is carried out by placing the first and second batches of porous solid in physical contact. For example, it is carried out in a storage or transport container.

According to one alternative embodiment, step a) of bringing said batches together is carried out in a chamber comprising two separate compartments that are in gaseous communication, said zones being suitable for containing, respectively, the first and second batches of porous solid so that the bringing together of the batches of support takes place without physical contact.

In one embodiment, the following steps are carried out:
a′) providing an initial batch of porous solid,
b′) heterogeneously impregnating the initial batch of porous solid with the organic compound in liquid form so as to provide a first batch of porous solid rich in organic compound and a second batch of a porous solid low in organic compound,
c′) leaving together said batches of porous solids resulting from step b′), under temperature, pressure and time conditions such that a fraction of said organic compound is transferred gaseously from the first batch of porous solid to the second batch of porous solid.

In another embodiment, the following steps are carried out:
a″) providing an initial batch of porous solid,
b″) separating said initial batch into first and second separate fractions,
c″) introducing the organic compound in liquid form into the first fraction of solid resulting from step b″) so as to provide the first batch of solid rich in organic compound,
d″) bringing the first batch of support rich in organic compound resulting from step c″) together with the second fraction of solid resulting from step b″) under temperature, pressure and time conditions such that a fraction of said organic compound is transferred gaseously from the first batch of porous solid to the second batch of porous solid.

Within the context of the invention, it is possible to carry out step a) in the presence of a flow of a carrier gas.

According to one embodiment, at least one fraction of the porous solid resulting from the bringing-together step a) is separated and said fraction is recycled to step a).

Step a) is preferably carried out at an absolute pressure of between 0 and 1 MPa.

According to the invention, the porous solid is chosen from a catalyst support and a catalyst support further comprising at least one metal from group VIB and/or at least one metal from group VIII. Preferably, the porous support is based on an oxide of a metal and/or of a metalloid. For example, the porous support is based on alumina and/or silica.

The process for adding the organic compound according to the invention may be incorporated into a line for producing catalyst said to be additivated with an organic compound.

One subject of the present invention is therefore a process for preparing a catalyst comprising a porous support, at least one metal from group VIB and/or at least one metal from group VIII and at least one organic compound. The preparation process comprising at least the following steps:
i) carrying out the process for adding at least one organic compound by bringing the porous support together with a porous solid containing said organic compound so as to provide a batch of porous support containing said organic compound,
ii) depositing at least one metal from group VIB and/at least one metal from group VIII on the porous support by bringing the support into contact with a solution containing at least one precursor of said metal(s) from group VIII and/or at least one precursor of said metal(s) from group VIB,
iii) drying the porous support resulting from step ii),
   step i) being carried out separately before or after steps ii) and iii).

The process of adding the organic compound according to the invention may be carried out one or more times in an additivated catalyst production line in order to introduce one or more organic compounds before the step of impregnation of the active metal phase, and/or to enable the introduction of one or more organic compounds on a porous support that already contains an active metal phase which may optionally be sulfided.

According to a first embodiment A) of the process for preparing a catalyst additivated with an organic compound, the porous support is subjected to a step of impregnation with a solution comprising at least one metal from group VIB and/or at least one metal from group VIII so as to deposit an active metal phase (step ii). The porous support impregnated with the active metal phase is optionally subjected to a maturing step then is dried (step iii) in order to eliminate the solvent introduced by step ii). The dried porous support containing the active metal phase is subjected to a step of adding the organic compound according to step i) so as to provide a catalyst additivated with said organic compound. The catalyst support used in this embodiment A) of the preparation process may also already contain one or more organic compounds different from the one which is used in step i). This or these additional organic compounds may have been incorporated into the porous catalyst support using the addition process according to the invention or according to any other method known to a person skilled in the art.

According to another embodiment B) of preparation, the support containing no active metal phase is firstly subjected to a step of adding the organic compound according to step i) so as to provide an additivated catalyst support, which is sent to the step of impregnation of the active phase (step ii). This step may consist in bringing the additivated support into contact with a solution containing at least one precursor of at least one metal from group VIII and/or at least one precursor of at least one metal from group VIB. The additivated catalyst thus obtained is optionally left maturing and then subjected to a drying step (step iii) with a view to eliminating the solvent introduced during the step of impregnation of the metal precursors of the active phase. In this embodiment B), the porous support used may optionally already contain one or more organic compounds different from the one used in step i), the additional organic compound(s) having been incorporated into the catalyst support using the addition process according to the invention or according to any other method known to a person skilled in the art.

It should be noted that within the context of the invention, step ii) of introducing the metals may use a solution containing at least one precursor of said metal(s) from group VIII and/or at least one precursor of said metal(s) from group VIB and in addition one or more organic compounds different from the one from step i). According to the invention, the additivated catalyst obtained at the end of steps i) to iii) described above may also be treated by one or several subsequent steps in order to incorporate one or more other additional organic compounds different from the one used in step i). The incorporation of one or more different additional organic compounds may be carried out using the addition process according to the invention or according to any other method known to a person skilled in the art. The other additional organic compound(s) may for example be introduced according to one of the embodiments described in document FR 3 035 008.

The additivated catalysts prepared according to the invention may contain, as active phase, one or more metals from group VIB and/or from group VIII. The preferred metals from group VIB are molybdenum and tungsten and the preferred metals from group VIII are non-noble elements and in particular cobalt and nickel. Advantageously, the active phase is chosen from the group formed by the combinations of the elements cobalt-molybdenum, nickel-molybdenum, nickel-tungsten or nickel-cobalt-molybdenum, or nickel-molybdenum-tungsten.

According to the invention, the catalysts generally have a total content of metals from group VIB and/or from group VIII of greater than 6% by weight expressed as oxide relative to the total weight of dry catalyst.

Preferably, the total content of metals from group VIB is between 5% and 40% by weight, preferably between 8% and 35% by weight, and more preferably between 10% and 32% by weight expressed as oxide of metal from group VIB relative to the total weight of dry catalyst. The total content of metals from group VIII is generally between 1% and 10% by weight, preferably between 1.5% and 9% by weight, and more preferably between 2% and 8% by weight expressed as oxide of metal from group VIII relative to the total weight of dry catalyst. The molar ratio of metals from group VIII to metals from group VIB in the catalyst is preferentially between 0.1 and 0.8, preferably between 0.15 and 0.6 and more preferably still between 0.2 and 0.5.

The catalyst may also comprise phosphorus as dopant. The content of phosphorus in said catalyst is preferably between 0.1% and 20% by weight expressed as P₂O₅, preferably between 0.2% and 15% by weight expressed as P₂O₅, and very preferably between 0.3% and 11% by weight expressed as P₂O₅ relative to the total weight of dry catalyst.

The molar ratio of phosphorus to metals from group VIB in the catalyst is greater than or equal to 0.05, preferably greater than or equal to 0.07, preferably between 0.08 and 1, preferably between 0.01 and 0.9 and very preferably between 0.15 and 0.8.

The catalyst may advantageously further contain at least one dopant chosen from boron, fluorine and a mixture of boron and fluorine. When the catalyst contains boron, the boron content is preferably between 0.1% and 10% by weight expressed as boron oxide, preferably between 0.2% and 7% by weight, and very preferably between 0.2% and 5% by weight relative to the total weight of the dry catalyst. When the catalyst contains fluorine, the fluorine content is preferably between 0.1% and 10% by weight expressed as fluorine, preferably between 0.2% and 7% by weight, and very preferably between 0.2% and 5% by weight relative to the total weight of dry catalyst.

The additivated catalysts thus prepared are notably used for reactions for hydrotreating hydrocarbon feedstocks such as petroleum cuts or for the synthesis of hydrocarbons from synthesis gas. According to the invention, the term “hydrotreating” notably encompasses the reactions of total or selective hydrogenation, hydrodenitrogenation, hydrodearomatization, hydrodesulfurization, hydrodeoxygenation, hydrodemetallization, and hydrocracking of hydrocarbon feedstocks.

For hydrotreating applications, the additivated catalyst generally undergoes a sulfiding step. The feedstocks used in the hydrotreating process are for example gasolines, gas oils, vacuum gas oils, atmospheric residues, vacuum residues, atmospheric distillates, vacuum distillates, heavy fuel oils, oils, waxes and paraffins, used oils, deasphalted residues or crudes, feedstocks originating from thermal or catalytic conversion processes, lignocellulosic feedstocks, or feedstocks derived from biomass, taken alone or as a mixture. The operating conditions used in the processes carrying out reactions for hydrotreating hydrocarbon feedstocks described above are generally the following: the temperature is advantageously between 180° C. and 450° C., and preferably between 250° C. and 440° C., the pressure is advantageously between 0.5 and 30 MPa, and preferably between 1 and 18 MPa, the hourly space velocity is advantageously between 0.1 and 20 h⁻¹ and preferably between 0.2 and 5 h⁻¹, and the hydrogen/feedstock ratio expressed as a volume of hydrogen, measured under normal temperature and pressure conditions, per volume of liquid feedstock is advantageously between 50 l/l to 5000 l/l and preferably between 80 to 2000 l/l.

### DETAILED DESCRIPTION OF THE INVENTION

One subject of the present invention is a process for adding an organic compound to a porous solid which is for example a porous catalyst support or to a porous support which already contains at least one metal from group VIB and/or at least one metal from group VIII that will be denoted by the term “catalyst precursor” in the remainder of the description. The porous support is based on at least one oxide of a metal or of a metalloid. Preferably, the porous support is based on alumina or silica or silica-alumina.

When the support is based on alumina, it contains more than 50% by weight of alumina.

Preferably, the alumina is gamma alumina.

Alternatively, the support is a silica-alumina, i.e. it contains at least 50% by weight of alumina.

The content of silica in the support is at most 50% by weight, usually less than or equal to 45% by weight, preferably less than or equal to 40% by weight.

When the support of said catalyst is based on silica, it contains more than 50% by weight of silica and, generally, it contains only silica.

According to one particularly preferred variant, the support consists of alumina, silica or silica-alumina.

The support may also advantageously further contain from 0.1% to 50% by weight of zeolite.

Preferably, the zeolite is chosen from the group FAU, BEA, ISV, IWR, IWW, MEI, UWY and preferably, the zeolite is chosen from the group FAU and BEA, such as the Y and/or beta zeolite.

In certain particular cases, the support may contain at least one dopant element, such as for example phosphorus.

The porous solid has a total pore volume of between 0.1 and 1.5 cm³/g, preferably between 0.4 and 1.1 cm³/g. The total pore volume is measured by mercury porosimetry according to the standard ASTM D4284 with a wetting angle of 140°, such as described in the book by Rouquerol F.; Rouquerol J.; Singh K., “Adsorption by Powders & Porous Solids: Principle, methodology and applications”, Academic Press, 1999, for example by means of an Autopore III™ model device from the brand Microméritics™.

The specific surface area of the porous solid is advantageously between 5 and 400 m²/g, preferably between 10 and 350 m²/g, more preferably between 40 and 350 m²/g. The specific surface area is determined in the present invention by the BET method according to the standard ASTM D3663, method described in the same book cited above.

The porous solid is generally in the form of beads, of extrudates, of pellets or of irregular and nonspherical agglomerates, the specific shape of which may result from a crushing step.

As mentioned above, the process of adding the organic compound may be carried out on a porous solid which is a catalyst precursor, i.e. on a porous support further comprising at least one metal from group VIB and/or at least one metal from group VIII. The groups of chemical elements are given according to the CAS classification (CRC Handbook of Chemistry and Physics, published by CRC Press, Editor in Chief D. R. Lide, 81st edition, 2000-2001). For example, Group VIII according to the CAS classification corresponds to the metals of columns 8, 9 and 10 according to the new IUPAC classification.

Within the context of the invention, the catalyst precursor may be a precursor of fresh catalyst, i.e. that has not been used beforehand in a catalytic unit and notably in hydrotreating and/or hydrocracking.

The catalyst precursor according to the invention may also be a so-called “regenerated” catalyst. The term “regenerated catalyst” denotes a catalyst which has been previously used in a catalytic unit and notably in hydrotreating and which has been subjected to at least one calcining step in order to burn off the coke (regeneration).

The process of adding the organic compound according to the invention consists in bringing together, in an open or closed chamber, a first batch of porous solid rich in an organic compound which has been previously deposited on said solid in the liquid state with a second batch of porous solid low in said organic compound. The objective of this bringing together of the porous solids is to enable a gaseous transfer of a portion of the organic compound contained in the first batch of porous solid to the second batch of porous solid. According to the invention, the term “low in organic compound” notably covers the case where the second batch of porous solid is free of said organic compound.

The process according to the invention is based on the principle of the existence of a vapor pressure of the organic compound at a given temperature and a given pressure. Thus, a portion of the molecules of organic compound of the batch of porous solid rich in organic compound passes into gaseous form (vaporization) and is then transferred (gaseously) to the solid low in organic compound. According to the invention, the porous solid rich in organic compound acts as a source of organic compound for enriching with organic compound the porous solid low in organic compound. Within the context of the invention, the porous solid (for example a porous catalyst support or a catalyst precursor) rich in organic compound is obtained by impregnation with the organic compound in the liquid state. Unlike the prior art, the organic compound is not diluted in a solvent. One advantage of the process according to the invention compared to the prior art processes therefore lies in the absence of a drying step which is conventionally used for eliminating the solvent after the impregnation step and therefore of being less energy-consuming compared to conventional processes. This absence of drying step makes it possible to prevent possible losses of organic compound by vaporization or even by degradation. The process according to the invention requires a smaller number of individual steps.

The volume of organic compound used is strictly less than the total volume of the accessible porosity of the solids used in step a) and is set relative to the targeted amount of organic compound on the batches of solids at the end of the bringing-together step a). Another advantage of the invention is therefore the use of a smaller amount of organic compound relative to the case of the prior art where, in the absence of solvent, the entire porosity would have to be filled with organic compound.

The (first batch of solid rich in organic compound)/(second batch of solid low in organic compound) weight ratio depends on the pore distribution of the solids and on the objective in terms of targeted amount of organic compound on the solids resulting from the bringing-together step a). This weight ratio is generally less than or equal to 10, preferably less than or equal to 2 and more preferably still between 0.05 and 1, limits included.

According to the invention, step a) of bringing together the porous solids is carried out under temperature, pressure and time conditions so as to achieve a balance of the amount of organic compound on both batches of porous solid. The term “balance” is understood to denote the fact that at the end of the bringing-together step a) at least 50% by weight of the first and second batches of porous solids have an amount of said organic compound equal to plus or minus 50% of the targeted amount, preferably at least 80% by weight of the first and second batches of porous solids have an amount of said organic compound equal to plus or minus 40% of the targeted amount and more preferentially still at least 90% by weight of the first and second solids have an amount of said organic compound equal to plus or minus 20% of the targeted amount.

By way of nonlimiting example, in the case where the preparation of a porous solid comprising 5% by weight of organic compound is targeted, it is possible to bring together, in a same amount, a first batch of porous solid containing 10% by weight of organic compound with a second batch of the same solid but free of said organic compound. It will be considered in this case that the balance is achieved when at least 50% by weight of the porous solids have an amount of said organic compound that corresponds to a content of between 2.5% and 7.5% by weight, preferentially when at least 80% by weight of the solids have an amount of said organic compound which corresponds to a content that is between 3% and 7% by weight, and more preferentially still when at least 90% by weight of the solids have an amount of said organic compound which corresponds to a content of between 4% and 6% by weight.

These contents may be determined by a statistically representative sampling for which the samples may be characterized for example by assaying of the carbon and/or possible heteroatoms contained in the organic compound or by thermogravimetry coupled to an analyser, for example a mass spectrometer, or an infrared spectrometer and thus determine the respective contents of organic compounds.

The step of bringing together batches of porous solids is preferably carried out under controlled temperature and pressure conditions and so that the temperature is below the boiling point of said organic compound to be transferred gaseously. Preferably, the operating temperature is below 150° C. and the absolute pressure is generally between 0 and 1 MPa, preferably between 0 and 0.5 MPa and more preferably between 0 and 0.2 MPa. It is thus possible to carry out the bringing-together step in an open or closed chamber, optionally with a control of the composition of the gas present in the chamber.

When the step of bringing together the porous solids is carried out in an open chamber, it will be ensured that the entrainment of the organic compound out of the chamber is limited as much as possible. Alternatively, the step of bringing together the porous solids may be carried out in a closed chamber, for example in a container for storing or transporting the solid that is impermeable to gas exchanges with the outside environment.

Within the context of the invention, the bringing-together step may be carried out by controlling the composition of the gas forming the atmosphere by introducing one or more gaseous compounds optionally with a controlled moisture content. As nonlimiting example, the gaseous compound may be carbon dioxide, ammonia, air with a controlled moisture content, an inert gas such as argon, nitrogen, hydrogen, natural gas or a refrigerant gas according to the classification published by IUPAC. According to one advantageous embodiment, the step of bringing together in a controlled gaseous atmosphere uses a forced circulation of the gas in the chamber.

According to one preferred embodiment, the step of bringing together batches of porous solids is carried out by placing said batches in physical contact optionally with a step of mixing the batches before or during step a). This embodiment may be advantageously carried out in a container for transporting or storing the porous solid, at ambient temperature and under atmospheric pressure.

Alternatively, the step of bringing together batches of porous solids is carried out without physical contact in a chamber equipped with compartments suitable for containing, respectively, the first and second batches of porous solids, the compartments being in communication so as to allow the passage of the organic compound in the gaseous state between the two compartments. In this embodiment, it is advantageous to circulate a gas stream firstly through the compartment containing the porous solid rich in organic compound then through the compartment containing the porous solid low in organic compound.

Any organic compound which is in the liquid state at the temperature and pressure used in the step of adding the organic compound to the porous solid in order to provide the first batch of porous solid rich in organic compound, may be used in the process according to the invention. The organic compound may, for example, be chosen from organic molecules containing oxygen and/or nitrogen and/or sulfur. The organic compound is, for example, chosen from a compound comprising one or more chemical functions chosen from a carboxylic, alcohol, thiol, thioether, sulfone, sulfoxide, ether, aldehyde, ketone, ester, carbonate, amine, nitrile, imide, oxime, urea and amide function. By way of example, it may be chosen from triethylene glycol, diethylene glycol, ethylene glycol, propylene glycol, diethylene glycol monomethyl ether, diethylene glycol monobutyl ether, ethylene glycol monobutyl ether, 1,4-butanediol, 1-pentanol, malonic acid, succinic acid, γ-ketovaleric acid, maleic acid, citric acid, alanine, glycine, iminodiacetic acid, nitrilotriacetic acid, orthophthalic acid, diethylformamide, dimethylformamide, methyl acetoacetate, dimethyl succinate, 2-methoxyethyl 3-oxobutanoate, 2-(methacryloyloxy)ethyl 3-oxobutanoate, γ-valerolactone, 4-hydroxyvaleric acid, 2-pentenoic acid, 3-pentenoic acid, 4-pentenoic acid, 2-acetylbutyrolactone, 2-(2-hydroxyethyl)-3-oxobutanoic acid, 3-hydroxy-2-(2-hydroxyethyl)-2-butenoic acid, N-methylpyrrolidone, propylene carbonate, sulfolane, diethyl phosphite, triethyl phosphite, triethyl phosphate, acetophenone, tetramethylurea, thioglycolic acid. Within the context of the invention, it is also possible to use a composition consisting of a mixture of aforementioned organic compounds for preparing a first batch of solid rich in a mixture of organic compounds.

According to one particular embodiment, the first batch of porous solid rich in organic compound is only used as a carrier of organic compound and is separated from the batch of porous solid recovered at the end of the bringing-together step. In this embodiment and when the batches of solids rich and low in organic compound are mixed, use will be made of a first batch of porous solid which has at least one physical characteristic that distinguishes it from the other batch of porous solid.

The porous solid obtained at the end of the bringing-together step a) is advantageously used for the preparation of catalysts useful for example in processes for refining hydrocarbon feedstocks or else for the synthesis of hydrocarbons from a synthesis gas (Fischer-Tropsch synthesis). Thus, the process of adding the organic compound according to the invention may be carried out one or more times in an additivated catalyst production line in order to introduce one or more organic compounds before the step of impregnation of the active metal phase, and/or to enable the introduction of one or more organic compounds on a porous support that already contains an active metal phase which may optionally be sulfided. Within the context of the invention, it is also possible to introduce, during the catalyst preparation process, one or more other additional organic compounds different from the one used in step i) described above. The introduction of the additional organic compound(s) may be carried out using any method known to a person skilled in the art, such as for example those described in document FR 3 035 008. For example, it is possible to use, in step ii), a solution containing the metal(s) of the active phase and one or more additional organic compounds. Alternatively, it is also possible to carry out one or more steps of impregnation of the additional organic compound(s) with a solution, for example aqueous solution, containing one or more additional organic compounds.

When the catalyst is intended to carry out hydrotreating reactions, the catalyst containing the porous support, a metallic active phase and one or more organic compounds is subjected to a sulfiding step in order to convert the metal oxides into sulfides, optionally preceded by a drying step in order to eliminate the solvent introduced during the step of introducing the metallic phase.

The additivated catalysts thus prepared are notably used for reactions for hydrotreating hydrocarbon feedstocks such as petroleum cuts or for the synthesis of hydrocarbons from synthesis gas. According to the invention, the term “hydrotreating” notably encompasses the reactions of total or selective hydrogenation, hydrodenitrogenation, hydrodearomatization, hydrodesulfurization, hydrodeoxygenation, hydrodemetallization, and hydrocracking of hydrocarbon feedstocks.

For hydrotreating applications, the additivated catalyst generally undergoes a sulfiding step. The feedstocks used in the hydrotreating process are for example gasolines, gas oils, vacuum gas oils, atmospheric residues, vacuum residues, atmospheric distillates, vacuum distillates, heavy fuel oils, oils, waxes and paraffins, used oils, deasphalted residues or crudes, feedstocks originating from thermal or catalytic conversion processes, lignocellulosic feedstocks, or feedstocks derived from biomass, taken alone or as a mixture.

Other subjects and advantages of the invention will become apparent on reading the description which follows of specific exemplary embodiments of the invention, given by way of nonlimiting examples, the description being made with reference to the appended figures described below.

### BRIEF DESCRIPTION OF THE FIGURES

FIG. 1 is a diagram illustrating the principle of adding an organic compound according to standard practice known to a person skilled in the art;

FIG. 2 is a diagram illustrating the process according to the invention for adding an organic compound according to a first embodiment;

FIG. 3 shows a diagram of the process for adding an organic compound according to another embodiment;

FIG. 4 is a diagram of the process for adding an organic compound according to a third embodiment.

Generally, similar elements are denoted by identical references in the figures.

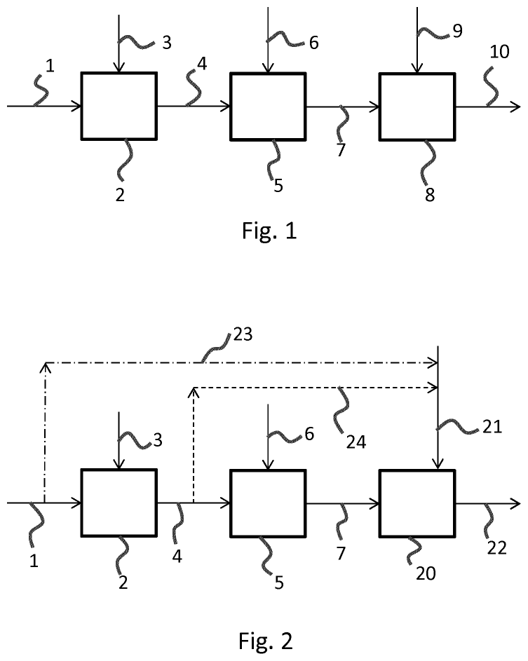

FIG. 1 corresponds to a block diagram presenting a known process for adding an organic compound to a porous catalyst support or a catalyst precursor as described previously that is denoted hereinbelow by the generic term “porous solid”.

The batch of solid 1 is subjected to an optional pretreatment in a unit 2 for pretreatment of the solid 1 intended, if need be, to condition the solid before the step of impregnation of the organic compound. This pretreatment step may, for example and depending on the desired effect, be a preliminary drying step in order to adjust the residual moisture content.

This pretreatment may also be an addition by controlled addition of the same solvent, introduced through the line 3, as the one which is used during the impregnation of the organic compound in order to avoid too lively a reaction of the solid during the organic compound impregnation phase. The type of reaction that it is desired to avoid is for example a great release of heat linked to the sudden adsorption of the solvent (such as water for example) on the active sites of the solid.

The batch of solid 4 resulting from the pretreatment step is sent to a unit 5 for impregnation of the organic compound. According to the prior art, this step uses a solution containing a solvent, for example water, in which the organic compound to be impregnated is dissolved. In FIG. 1, the impregnation solution is conveyed by the line 6. The impregnation is carried out according to any method known to a person skilled in the art and for example by a dry impregnation. In this impregnation method, the solid set in motion is subjected to a jet of the impregnation solution, the volume of solution sprayed generally being equivalent to the whole of the pore volume of the solid to be impregnated which is accessible to the solution. In accordance with prior art practice, the impregnated solid is discharged via the line 7 into a drying unit 8 in order to eliminate the solvent which was incorporated in the solid at the same time as the organic compound. The stream 9 represents the hot utility that is used to dry the solid, which is for example hot air. This results in a dry solid 10 impregnated with the chosen organic compound. Depending on the organic compound chosen and its solubility in the solvent used during the impregnation step, it is possible that the amount introduced is not sufficient at the end of a single impregnation step. In which case, use may be made of several impregnation and drying steps described above.

After impregnation of the organic compound, the solid may undergo one or more steps of impregnation of one or more metals from group VIB and/or from group VIII in order to deposit a metal catalytic phase. The impregnation step(s) may be followed, optionally after a maturing step, by a step of drying at a moderate temperature, generally below 200° C.

FIG. 2 depicts the process according to the invention for adding an organic compound according to a first embodiment. The solid 1 having been, if necessary, conditioned in a pretreatment unit 2 is transferred via the line 4 into the unit 5 for introducing the organic compound. In accordance with the invention, this impregnation step is carried out with the organic compound which is in the liquid state introduced via the line 6. The volume of liquid organic compound which is used is chosen so that it is strictly less than the pore volume of the total batch of porous solid 1 and of porous solid 2 which is accessible to the liquid organic compound.

The solid rich in organic compound is discharged from the unit 5 for introducing the organic compound via the line 7 to a unit 20 in which said solid is brought together, preferably under controlled conditions (pressure/temperature/composition of the gaseous atmosphere), with another batch of porous solid 2 low in said organic compound, for example the amount of organic compound of the batch of porous solid 2 is zero. The objective of the step of bringing together the solids in the unit 20 is to carry out the gaseous transfer of a portion of the organic compound contained in the solid rich in organic compound to the solid low in organic compound in order to provide, at the end of the balancing, the batch of solid 22 impregnated with said organic compound. The nature and the pore structure of the solid rich in organic compound and of the solid low in organic compound are also parameters which may be taken into account. Thus the chemical composition of the solid rich in organic compound may be such that its adsorptivity with respect to the organic compound is lower than that of the solid to be additivated. A similar effect may be obtained by adapting the porous structure of the solid rich in organic compound so that it has a mean pore opening that is greater than that of the solid to be impregnated so as to favor the transfer to the solid low in organic compound, particularly in the case of a mechanism involving capillary condensation.

As indicated in FIG. 2, when the solids are of the same nature, the solid low in organic compound may be chosen from the solid 23 before pretreatment or the pretreated solid 24.

The step of bringing together the solids according to the invention may be carried out with or without physical contact of the two batches of solids. When said step of bringing together the solids is carried out with physical contact of the solids, the solids may be mixed before or during the bringing-together step.

According to the invention, the bringing-together step a) is carried out at a temperature below the boiling point of the organic compound at the chosen pressure. For example, the temperature may be below 150° C. and for a range of absolute pressure between 0 and 1 MPa. The duration of this step is chosen so as to obtain a balance as described previously. Generally, the higher the temperature and the lower the pressure, the shorter this time will be, which will be favorable for integrating this step into a rapid production line. Typically, the duration is less than 24 hours, preferentially less than 5 hours and preferably less than 1 hour.

Within the context of the invention, the unit 20 enabling the solids to be brought together is for example a chamber, preferably a closed chamber. To enable the solids to be brought together without physical contact between the solids, it is possible to use a compartmentalized chamber so as to receive, in two respective compartments, the solid rich in organic compound and the solid low in organic compound, the compartments being configured to allow the passage of the organic compound in the gaseous state between the two compartments.

According to the invention, the bringing-together step may also be carried out in a suitable storage or transport container into which the mixed solids are placed in bulk. This type of use may be practiced when the balancing time is not critical. The pressure and temperature conditions may then be close to ambient and the time for bringing together the solids (from several days to several weeks) corresponds to the time needed for transporting the solids from the production site to the site of use of the solids, optionally with an additional storage time at the end user's premises.

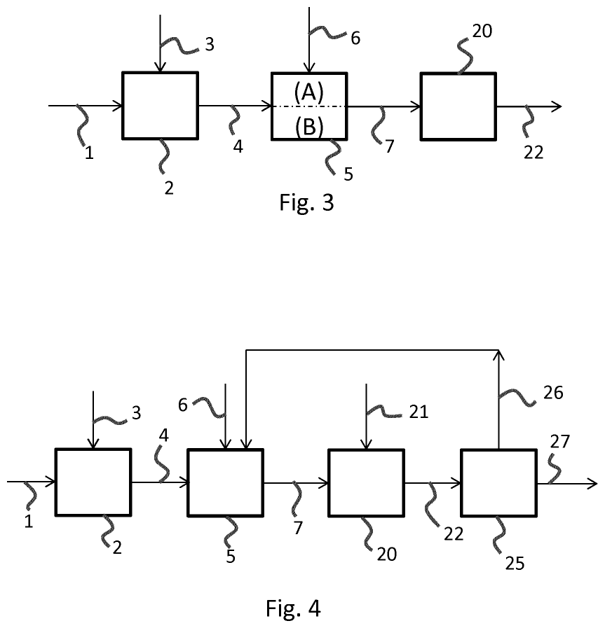

FIG. 3 represents another embodiment of the process for adding the organic compound according to the invention which differs from that of FIG. 2 by the fact that the batches of solid rich in organic compound and of solid low in organic compound are obtained at the same time at the end of the step of impregnating a fraction of an initial batch of porous solid.

With reference to FIG. 3, a stream of conditioned solid withdrawn from the unit 2 for pretreatment of the solid is sent via the line 4 to the step of introducing the organic compound in the liquid state. The introduction step which is carried out in the unit 5 differs from that of FIG. 2 in that it is carried out so that only a fraction of the solid is bought into contact with the liquid organic compound introduced by the line 6. At the end of this step, two fractions of solids A and B having different contents of organic compound are obtained. By way of nonlimiting example, the impregnation step according to the embodiment of FIG. 3 may consist in spreading the organic compound in the liquid state, for example by means of a dispersion device, on the surface of the batch of solid so as to provide a fraction of solid A rich in organic compound and a fraction of solid B low in organic compound. For example, this step of impregnating the batch of solid may be carried out in a unit 5 comprising a belt conveyor for conveying the solid and which unit is equipped with the liquid dispersion device. At the end of the impregnation step, the batches of solids A and B are left together with one another. For example, they are brought together in the unit 5 for introducing the liquid organic compound or in a dedicated unit 20 as indicated in FIG. 3. Preferably, the fractions A and B are mixed after the step of introducing the liquid organic compound.

Another embodiment of the process for adding an organic compound to a solid (a porous catalyst support or a catalyst precursor) is depicted in FIG. 4. This embodiment according to the invention corresponds to the case where the porous solid containing the organic compound acts as a reservoir of organic compound for the step of bringing the solids together. As indicated in FIG. 4, a so-called “carrier” porous solid 4, optionally pretreated in a conditioning unit 2 as described above, is impregnated in the impregnation unit 5 with a liquid organic compound introduced via the line 6. The carrier solid 7 rich in said organic compound is transferred into the unit 20 in which said carrier solid is brought together with a so-called porous solid “of interest” low in organic compound conveyed via the line 21. For example, the porous solid may have a zero amount of said organic compound.

At the end of the step of bringing the solids together, a mixture of carrier solid and solid of interest, each containing said organic compound, is withdrawn from the unit via the line 22. The mixture of solids is then sent to a separation unit 25 which carries out a physical separation of the carrier solid and solid of interest. Owing to the use of the separation, two streams of solids are obtained, namely the carrier solid 26 containing the organic compound and the solid of interest 27 also containing the organic compound.

In accordance with this embodiment, the carrier solid still containing the organic compound 26 is recycled to the unit for introducing the liquid organic compound for subsequent use. In this embodiment, the carrier solid has at least one discriminating physical feature with respect to the solid of interest in order to enable the separation thereof. For example and nonlimitingly, this physical feature may be:
the size of the particles of the solid: the separation may be carried out through a screen
magnetism: the separation is carried out by the application of a magnetic field
the density of the solid: optionally in conjunction with the size of the particles, this difference in density may for example be used for a separation via elutriation.

The nature and the porous structure of the carrier solid and of the solid of interest are also parameters to be taken into account. Thus, the carrier solid has a chemical composition suitable for disfavoring the adsorption of the compound to be impregnated relative to the adsorption of the compound to be impregnated on the solid of interest. A similar effect may be obtained by adapting the porous structure of the carrier solid so that it has a mean pore opening that is greater than that of the solid of interest so as to favor the transfer of the organic compound to the solid of interest, particularly in the case of a mechanism involving capillary condensation.

### EXAMPLES

The following examples specify the advantage of the invention without however limiting the scope thereof.

### Example 1: Preparation of CoMoP Catalysts on Alumina without Organic Compound C1 and C2 (According to the Prior Art)

To an alumina support in “extrudate” form, having a BET surface area of 230 m²/g, a mesopore volume measured by mercury porosimetry of 0.78 ml/g and a volume median diameter by mercury porosimetry of 11.5 nm, cobalt, molybdenum and phosphorus are added. The impregnation solution is prepared by dissolving, at 90° C., molybdenum oxide (21.1 g) and cobalt hydroxide (5.04 g) in 11.8 g of an 85 wt % aqueous solution of phosphoric acid. After drying, the extrudates are left to mature in a water-saturated atmosphere for 24 h at ambient temperature, then they are dried at 90° C. for 16 hours. The dried catalytic precursor thus obtained is denoted by C1. The calcination of the catalytic precursor C1 at 450° C. for 2 hours leads to the calcined catalyst C2. The metal composition of the catalyst precursor Cl and of the calcined catalyst C2 is: MoO₃=19.5±0.2 wt %, CoO=3.8±0.1 wt % and P₂O₅=6.7±0.1 wt %, the percentages being expressed relative to the weight of dry catalyst.

### Example 2: Preparation of the CoMoP Catalyst Additivated with Citric Acid on Alumina C3 (According to the Prior Art) by Co-Impregnation

To the alumina support described in example 1 and which is in the “extrudate” form, cobalt, molybdenum and phosphorus are added. The impregnation solution is prepared by dissolving, at 90° C., molybdenum oxide (28.28 g) and cobalt hydroxide (6.57 g) in 15.85 g of an 85 wt % aqueous solution of phosphoric acid. After homogenization of the preceding mixture, 38 g of citric acid were added before adjusting the volume of solution to the total pore volume of the support by addition of water. The amount of citric acid used is such that the (citric acid)/Mo molar ratio is equal to 1 mol/mol and the (citric acid)/Co molar ratio is equal to 2.7 mol/mol. After dry impregnation, the extrudates are left to mature in a water-saturated atmosphere for 24 h at ambient temperature, then they are dried at 120° C. for 16 hours. The catalyst additivated with citric acid thus obtained is denoted by C3. The final metal composition of the catalyst C3 relative to the mass of dry catalyst is then the following: MoO₃=19.6±0.2 wt %, CoO=3.7±0.1 wt % and P₂O₅=6.7±0.1 wt %.

### Example 3: Preparation of the CoMoP Catalyst Additivated with 2-methoxyethyl 3-oxobutanoate on Alumina C4 (According to the Prior Art) by Post-Impregnation

Added to 18 g of catalyst Cl described in example 1 and which is in the form of extrudates, are 3.2 g of 2-methoxyethyl 3-oxobutanoate diluted in water so as to obtain a solution having a total volume equal to the pore volume of the catalyst. The amount of organic compound added is such that the (2-methoxyethyl 3-oxobutanoate)/Mo molar ratio is 0.8 mol/mol or is 2.2 mol of 2-methoxyethyl 3-oxobutanoate per mole of cobalt. The extrudates are left to mature in a water-saturated atmosphere for 16 h at ambient temperature. The catalyst is then dried at 120° C. for 2 hours. The final metal composition of the catalyst C4 expressed in the form of oxides is: MoO₃=19.5±0.2 wt %, CoO=3.8±0.1 wt % and P₂O₅=6.7±0.1 wt % relative to the weight of dry catalyst.

### Example 4: Preparation of the CoMoP Catalyst on Alumina C5 (According to the Invention) by Introduction, After the Impregnation of the Metals, of a Solvent-Free Organic Compound at a Volume Less than that of the Porosity of the Solid to be Impregnated

Arranged in a closed chamber is a batch of 12 g of the catalyst precursor C1. 2.3 g (i.e. 1.9 ml) of 2-methoxyethyl 3-oxobutanoate in liquid form are dispersed on the surface of the batch of catalyst precursor Cl at ambient temperature and pressure. As in example 3, the amount of 2-methoxyethyl 3-oxobutanoate added is such that the (2-methoxyethyl 3-oxobutanoate)/Mo molar ratio is 0.8 mol/mol, i.e. 2.2 mol of 2-methoxyethyl 3-oxobutanoate per mole of cobalt. It will furthermore be noted that the volume of 1.9 ml of organic compound introduced is less than the total pore volume of the batch of catalyst precursor Cl used which is around 6.5 ml. Thus, at the end of the dispersion step, a batch of catalyst precursor rich in organic compound and a batch of catalyst precursor low in organic compound are obtained.

The closed chamber is placed in an oven at 120° C. for 6 hours. 14.1 g of catalyst C5 impregnated with the organic compound are thus obtained. The final metal composition of the catalyst C5 is: MoO₃=19.5±0.2 wt %, CoO=3.8±0.1 wt % and P₂O₅=6.7±0.1 wt % relative to the weight of dry catalyst. The catalyst C5 moreover has a (2-methoxyethyl 3-oxobutanoate)/Mo molar ratio of 0.8 mol/mol.

### Example 5: Preparation of the CoMoP Catalyst on Alumina C6 (According to the Invention) by Introduction, before the Impregnation of the Metals, of a Solvent-Free Organic Compound at a Volume Less than that of the Porosity of the Solid to be Impregnated

Arranged in a closed chamber is a batch of 8.4 g of the same support in the form of extrudates as the one used in example 1. 2.3 g (i.e. 1.9 ml) of 2-methoxyethyl 3-oxobutanoate in liquid form are dispersed on the surface of the batch of support at ambient temperature and pressure. In this example, the volume of organic compound introduced is less than the total pore volume of the batch of support which is around 7.4 ml. Thus, at the end of the dispersion step, a batch of catalyst precursor rich in organic compound and a batch of precursor low in organic compound are obtained.

The closed chamber is placed in an oven at 120° C. for 6 hours. At the end of this step,10.5 g of support impregnated with organic compound are thus obtained. As in example 4, the amount of 2-methoxyethyl 3-oxobutanoate introduced on the support is fixed so as to obtain, after impregnation of the metals, a (2-methoxyethyl 3-oxobutanoate)/Mo molar ratio of 0.8 mol/mol, i.e. 2.2 mol of (2-methoxyethyl 3-oxobutanoate) per mole of cobalt.

The support with the added 2-methoxyethyl 3-oxobutanoate is then impregnated with an impregnation solution prepared by dissolving, at high temperature, molybdenum oxide (2.4 g) and cobalt hydroxide (0.6 g) in 1.4 g of an 85 wt % aqueous solution of phosphoric acid. Water is added to the solution for impregnation of the metals so that its volume is equal to the total pore volume of the batch of additivated support. After dry impregnation, the extrudates were left to mature in a water-saturated atmosphere for 24 h at ambient temperature, then dried at 120° C. for 16 hours to result in the catalyst C6. The final metal composition of the catalyst C6 expressed in the form of oxides is the following: MoO₃=19.6±0.2 wt %, CoO=3.9±0.1 wt % and P₂O₅=6.8 ±0.1 wt % relative to the weight of dry catalyst. The catalyst C6 moreover has a (2-methoxyethyl 3-oxobutanoate)/Mo molar ratio of 0.8 mol/mol.

### Example 6: Evaluation in Hydrodesulfurization (HDS) of Diesel Fuel of the Catalysts C1, C2, C3 and C4 (Prepared According to the Prior Art) and C5 and C6 (Prepared by the Process According to the Invention)

The catalysts C1, C2, C3 and C4 (comparative) and C5 and C6 (prepared according to the invention) were tested in hydrodesulfurization of a diesel fuel feedstock.

The features of the diesel fuel feedstock used are the following:
Density at 15° C.: 0.8522 g/cm³,
Total sulfur content: 1.44% by weight.
Simulated distillation:
IP: 155° C.
10%: 247° C.
50%:315° C.
90%: 392° C.
FP: 444° C.

The test is carried out in an isothermal crossed fixed-bed pilot reactor, the fluids circulating from bottom to top. The catalysts are first sulfided in situ at 350° C. in the unit under pressure by means of the diesel fuel of the test to which 2 wt % of dimethyl disulfide are added.

The tests of hydrodesulfurization of the diesel fuel feedstock were carried out under the following operating conditions: a total pressure of 7 MPa, with a catalyst volume of 30 cm³, at a temperature of between 330 to 360° C. and with a hydrogen flow rate of 24 l/h and a feedstock flow rate of 60 cm³/h.

The catalytic performances of the catalysts tested are given in table 1. There are expressed in degrees Celsius starting from a comparative catalyst chosen as a reference (catalyst C2): they correspond to the temperature difference to be applied in order to attain 50 ppm of sulfur in the effluent. A negative value signifies that the target sulfur content is attained for a lower temperature and that there is therefore an increase in activity. A positive value signifies that the target sulfur content is attained for a higher temperature and that there is therefore a loss of activity.

TABLE 1

| Catalyst | | | | |
|---|---|---|---|---|
| (comparative | | Organic | | |
| or according | Organic | compound/ | | |
| to the | compound | Mo molar | Method of introducing | HDS |
| invention) | used | ratio | the organic compound | activity |
| C1 (comp) | — | — | — | Base |
| | | | | +1.0° C. |
| C2 (comp) | — | — | — | Base |
| C3 (comp) | Citric acid | 1.0 | Co-impregnation of the organic | Base- |
| | | | compound | 2.9° C. |
| C4 (comp) | 2-methoxyethyl | 0.8 | Post-impregnation of the organic | Base- |
| | 3-oxobutanoate | | compound | 5.7° C. |
| C5 (inv) | 2-methoxyethyl | 0.8 | Post-impregnation of the solvent-free | Base- |
| | 3-oxobutanoate | | organic compound at a volume less | 6.9° C. |
| | | | than that of the porosity of the solid | |
| | | | to be impregnated | |
| C6 (inv) | 2-methoxyethyl | 0.8 | Pre-impregnation of the solvent-free | Base- |
| | 3-oxobutanoate | | organic compound at a volume less | 6.5° C. |
| | | | than that of the porosity of the solid | |
| | | | to be impregnated | |

Table 1 clearly shows that the method of introducing the organic compound according to the invention makes it possible to avoid the use of a solvent and consequently of a drying step while introducing the adequate amount of organic compound to obtain catalysts that are at least as efficient as those prepared according to the prior art. Specifically, the catalysts C5 and C6 according to the invention are more efficient than all the other comparative catalysts. The increase is very significant in comparison with the catalysts that do not use an organic molecule (C1 and C2) or citric acid (C3) commonly used by a person skilled in the art. Furthermore, the catalysts C5 and C6 are more efficient than the catalyst C4 using the same organic molecule introduced according to a protocol well known to a person skilled in the art based on a post-additivation in aqueous solution. The organic compound may therefore be introduced according to the invention both before and after the impregnation of the metals. These examples therefore indeed show the feasibility and the relevance of the method of introducing an organic compound according to the invention in particular for preparing catalysts that may have performances at least as high as those of the catalysts of the prior art.

1. A process for adding an organic compound to a porous solid comprising a step a) wherein, in an open or closed chamber, a first batch of porous solid rich in an organic compound is brought together with a second batch of porous solid low in said organic compound, step a) being carried out under temperature, pressure and time conditions such that a fraction of said organic compound is transferred gaseously from the first batch of porous solid to the second batch of porous solid.

2. The process as claimed in claim 1, wherein the temperature of step a) is below the boiling point of the organic compound.

3. The process as claimed in claim 1 2, wherein the amount of said organic compound of the second batch of porous solid is zero.

4. The process as claimed in claim 1, wherein step a) is carried out by placing the first and second batches of porous solid in physical contact.

5. The process as claimed in claim 4, wherein step a) is carried out in a storage or transport chamber. process as claimed in claim 1, wherein step a) of bringing said batches together is carried out in a chamber comprising two separate compartments that are in gaseous communication, said compartments being suitable for containing, respectively, the first and second batches of porous solid so that the bringing together of the batches of support takes place without physical contact.

7. The process as claimed in claim 1, comprising the following steps:
a′) providing an initial batch of porous solid,
b′) heterogeneously impregnating the initial batch of porous solid with the organic compound in the liquid state so as to provide a first batch of porous solid rich in organic compound and a second batch of porous solid low in organic compound,
c′) leaving together, according to step a), said batches of porous solids resulting from step b′) under temperature, pressure and time conditions such that a fraction of said organic compound is transferred gaseously from the first batch of porous solid to the second batch of porous solid.

8. The process as claimed in 1, comprising the following steps:
a″) providing an initial batch of porous solid,
b″) separating said initial batch into first and second separate fractions,
c″) introducing the organic compound in the liquid state into the first fraction of solid resulting from step b″) so as to provide the first batch of solid rich in organic compound,
d″) bringing, according to step a), the first batch of support rich in organic compound resulting from step c″) together with the second fraction of solid resulting from step b″) under temperature, pressure and time conditions such that a fraction of said organic compound is transferred gaseously from the first batch of porous solid to the second batch of porous solid.

9. The process as claimed in claim 1, wherein step a) is carried out at an absolute pressure of between 0 and 1 MPa.

10. The process as claimed in claim 1, wherein step a) is carried out in the presence of a flow of a carrier gas.

11. The process as claimed in claim 1, wherein at least one fraction of the porous solid resulting from step a) is separated and said fraction is recycled to step a).

12. The process as claimed in claim 1, wherein the porous solid is chosen from a porous catalyst support and a porous catalyst support further comprising at least one metal from group VIB and/or at least one metal from group VIII.

13. The process as claimed in claim 12, wherein the porous support is based on an oxide of a metal and/or of a metalloid.

14. The process as claimed in claim 1, wherein the organic compound is chosen from organic molecules containing oxygen and/or nitrogen and/or sulfur.

15. A process for preparing a catalyst comprising a porous support, at least one metal from group VIB and/or at least one metal from group VIII and at least one organic compound, the process comprising at least the following steps:
i) carrying out the process for adding at least one organic compound as claimed in claim 1 by bringing the porous support together with a porous solid containing said organic compound so as to provide a batch of porous support containing said organic compound,
ii) depositing at least one metal from group VIB and/at least one metal from group VIII on the porous support by bringing the support into contact with a solution containing at least one precursor of at least one metal from group VIII and/or at least one precursor of at least one metal from group VIB,
iii) drying the porous support resulting from step ii),
step i) being carried out separately before or after steps ii) and iii).

16. The preparation process as claimed in claim 15, wherein the solution of step ii) further comprises at least one additional organic compound different from the organic compound used in step i).

17. The preparation process as claimed in claim 15, further comprising at least one step of impregnating the porous support with a solution comprising an organic compound different from the organic compound used in step i).

18. A process for hydrotreating a hydrocarbon feedstock wherein hydrogen, the hydrocarbon feedstock and a catalyst are brought into contact at a temperature between 180° C. and 450° C., at a pressure between 0.5 and 30 MPa, with an hourly space velocity of between 0.1 and 20 h⁻¹ and with a hydrogen/feedstock ratio expressed as volume of hydrogen, measured under normal temperature and pressure conditions, per volume of liquid feedstock of between 50 l/l to 5000 l/l, said catalyst having been prepared by a process as claimed in claim 15 and subjected to at least one sulfiding step.
